(19) United States
(12) Patent Application Publication
(10) Pub. No.: US 2005/0175129 A1
(43) Pub. Date: Aug. 11, 2005

(54) Echo canceller with model mismatch compensation

(75) Inventors: David Antoine Christian Marie Roovers, Eindhoven (NL); Rene Martinus Maria Derkx, Eindhoven (NL); Cornelis Pieter Janse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/520,870

(22) PCT Filed: Jun. 23, 2003
(86) PCT No.: PCT/IB03/02863

(51) Int. Cl. H04B 1/10

(52) U.S. Cl. 375/350

(57) ABSTRACT

An interference canceller is described, comprising an adaptive filter for modeling an interference, such as an echo or noise, and a spectral processor for processing the modeled interference together with near end speech and the interference. The interference canceller further comprises an interference model mismatch compensator coupled to the adaptive filter for providing a mismatch signal to the spectral processor, said mismatch signal showing a speech independent decay. With the model mismatch signal of the interference canceller the interference power spectrum can be estimated very accurately leading to a significant convergence improvement of the acoustic canceller. Especially in the initial convergence phase at the start of a communication session a high quality operation of the acoustic canceller is achieved, which is important as this determines the first quality impression of the user.

The present invention relates to an interference canceller comprising an adaptive filter for modeling an actual interference, and a spectral processor for processing the modeled interference together with near end speech and the actual interference.

The present invention also relates to a system, in particular a communication system, for example a hands-free communication device, such as a mobile telephone, a speech recognition system or a voice controlled system, which system is provided with such an interference canceller, to a method for canceling an interference, such as for example echo and/or noise, and to signals suited for use in the interference canceller.

Such an interference canceller, system and method are known from WO97/45995 (=EP-A-0843934). The known interference canceller has a far end input for an other communicating party, a near end output for a loudspeaker, a near end input for a local audio microphone, and a far end output to the other party. The interference canceller comprises an adaptive filter coupled to the loudspeaker and to the microphone, and a spectral residual interference processor coupled to the adaptive filter and to the microphone. The adaptive filter models an actual interference, such as an echo between the loudspeaker and the microphone in order to compensate the actual echo. The spectral processor then acts as a dynamic echo post processor for suppressing a residual echo or echo tail part not compensated for by the adaptive filter. At the start of a communication session between the far end party and the local party the respective adaptive filters are not capable of modeling the echo path between loudspeaker and microphone due to a lack of a sufficient far end input signal. This means that initially also the spectral processor receives no or only inadequate information about modeled echoes. So initially there is no interference cancellation at all and in this phase of the communication session echoes are not compensated sufficiently accurate. Only after some exchange of speech between the parties will the adaptive filters have been converged to a state of steady interference compensation, followed by a steady operation of the spectral interference post processor.

Therefore it is an object of the present invention to provide an interference canceller, whose capabilities of fast and accurately adjusting to changing communication conditions such as arising at the start of a communication session are improved.

Thereto the interference canceller according to the invention is characterized in that the interference canceller further comprises an interference model mismatch compensator coupled to the adaptive filter for providing a mismatch signal for the spectral processor, said mismatch signal showing a speech independent decay.

Similarly the method according to the invention is characterized in that an interference model mismatch signal is used for modeling the interference, which mismatch signal shows a speech independent decay.

The inventors found that although far end speech is required for the interference cancellers for starting up interference model, in particular echo and/or noise building by the adaptive filters, it is this same wanted speech—that is to be sent to the far end party—that is poorly echo compensated by the echo cancellers at the initial stage of the communication session. In addition the presence of near end speech at the initial stage precludes a fast convergence of the acquisition process performed by the adaptive filters and the spectral processors. Therefore an interference mismatch compensator is proposed, whose decaying interference compensation features do not depend on the wanted speech. Advantageously this results in a faster convergence of the interference modeling process, which is particularly important at the start up of the communication or after recovery thereof. Furthermore it safeguards a faster tracking and interference suppression in case of changing communication conditions, such as may arise when loudspeaker volumes, or interference properties in the room change. It is a further advantage that after such changes a more accurate interference canceling will be reached earlier in time.

Finally it is important to note that the solution presented here does not require application of a speech detector, which leads to a less critical, simplified and cost effective operation of the interference canceller according to the invention.

An embodiment of the interference canceller according to the present invention has the characterizing features outlined in claim 2.

The fast and accurately established interference modeling can advantageously be used by the step size estimator for quickly and reliably optimizing step size control for the adaptive filter.

Another embodiment of the interference canceller according to the invention has the characterizing features of claim 3.

Advantageously the ratio of a spectral measure of the near end speech and interference, and the modeled echo of the adaptive filter can be used for implementing the speech independent mismatch signal.

Speech independence can be acquired by making use of a pause in speech, such that the minimum of said ratio is determined over a time span, wherein the near end signal only comprises interference, in particular echo and/or noise. Such a time span preferably lasts at least 4 to 5 seconds.

In general the mentioned spectral measure is defined by some positive function of the spectral power concerned, such as the spectral magnitude, the squared spectral magnitude, the power spectral density or the Mel-scale spectral density.

At present the interference canceller, system and method according to the invention will be elucidated further together with their additional advantages, while reference is being made to the appended drawing, wherein similar components are being referred to by means of the same reference numerals.

In the drawing:

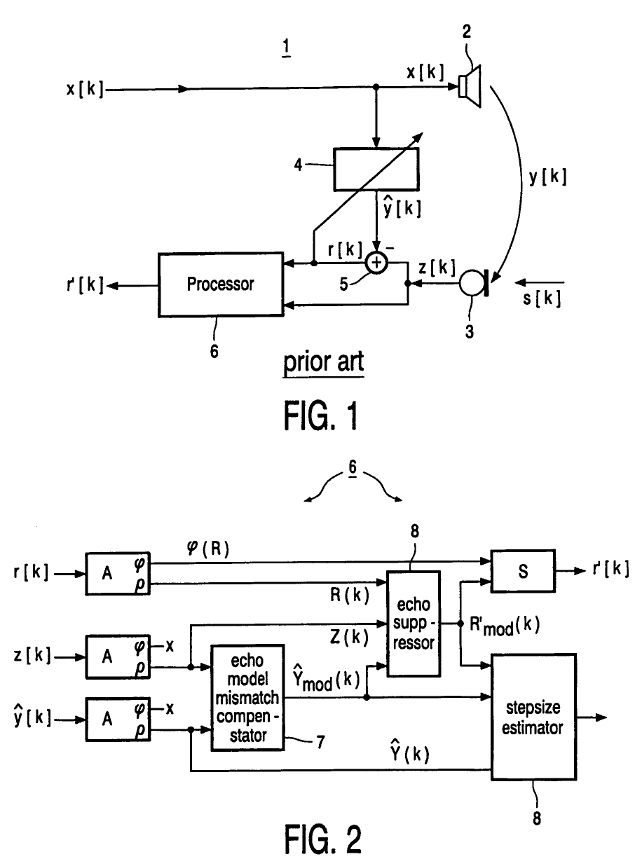

FIG. 1 shows a general outline of an interference canceller according to the prior art;

FIG. 2 shows an embodiment of a spectral processor for application in the interference canceller according to the invention;

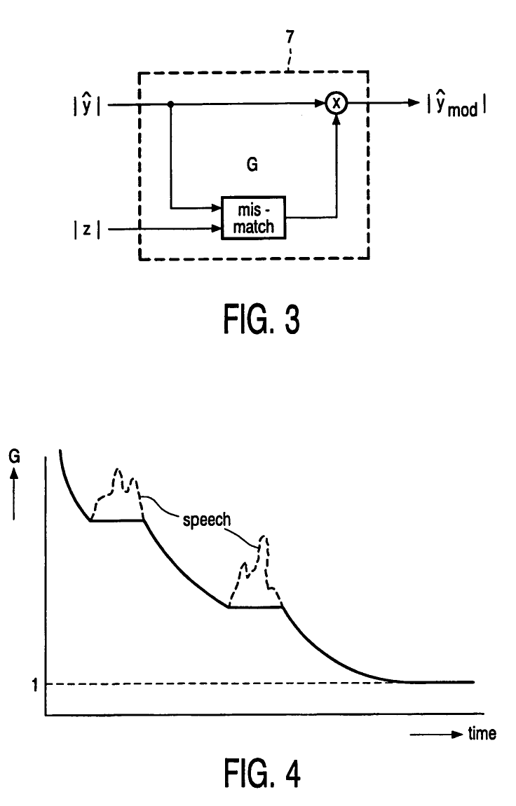

FIG. 3 shows a block diagram of a detailed interference model mismatch compensator for application in the interference canceller according to the invention;

FIG. 4 shows a graphical representation of the operation of the interference model mismatch compensator of FIG. 3, in the form of an echo model mismatch compensator, against time in the initial phase, where the adaptive filter model starts from all zero coefficients.

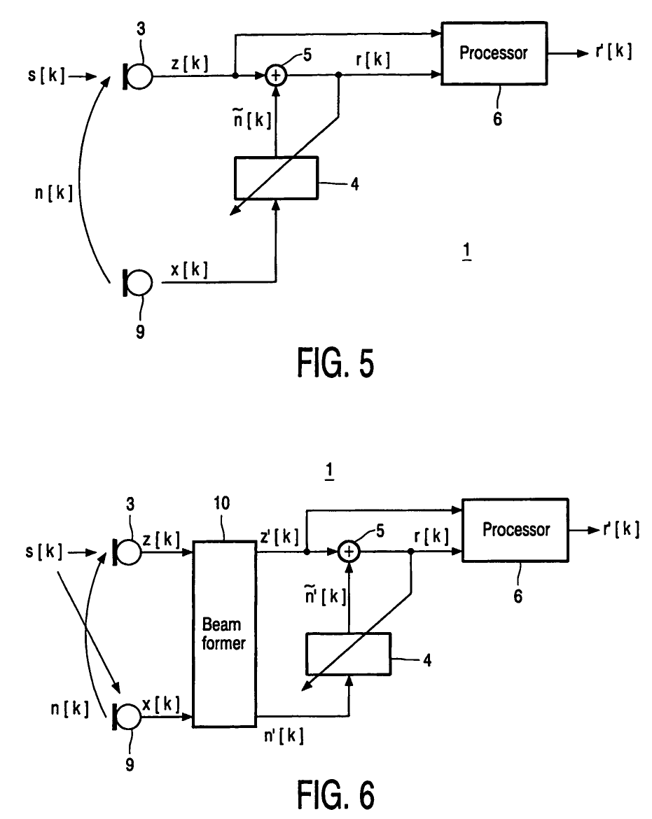

FIG. 5 shows an embodiment of the interference canceller according to the invention in the form of a noise canceller, wherein the loudspeaker in FIG. 1 has been replaced by a reference microphone; and

FIG. 6 shows an embodiment like FIG. 5 having a beam former.

FIG. 1 shows a shows a general outline of an interference canceller 1 at first to be described while embodied as an Acoustic Echo Canceller (AEC) 1. Such an AEC 1 is an important component in nowadays mostly full duplex communication systems, such as for example a speakerphone device, teleconferencing device, a telephone device, in particular a mobile telephone, a hands-free telephone or the like. In modem handsets, where a loudspeaker 2 and a microphone 3 are coupled to the AEC 1 and generally are mounted very close together, such an AEC removes annoying local echoes. The same applies for a teleconference device where mostly one or more loudspeakers and microphones are coupled to the AEC 1.

FIG. 1 shows a signal x[k] coming from a far end, which signal is reproduced by the loudspeaker 2 at the near end side. The index k indicates that the signal x is sampled. Apart from speech s[k] mainly originating from a near end speaker the microphone 3 also senses a signal y[k] comprising a reverberated far end echo generated through an echo path from the loudspeaker 2 to the microphone 3. So for a microphone signal z[k] at the near end it holds that z[k]=s[k]+y[k] (if noise n[k] is neglected). The AEC 1 operates by means of an adaptive filter 4 to generate an echo estimate signal y[k], which if subtracted from z[k] in adder 5 reveals a signal r[k], which ideally does not contain the echo signal y[k]. Ideally the signal r[k], which may be the output signal of the AEC 1, only comprises the wanted local near end signal s[k], hereafter called the speech signal. Thereto the adaptive filter 4 models the echo path represented by the echo estimate signal ŷ[k]. It is noted that two AECs are required at the far end and at the near end respectively in a communication device or communication network.

The AECs 1 operation may be extended by including a residual echo processor 6 therein. In that case the signal r′[k] is the output signal of the AEC 1. In practice the adaptive filter 4 is not always able to accurately model the transfer function of the acoustic path between the loudspeaker 2 and the microphone 3 due to its finite digital filter length, tracking problems and non linear effects. Processor 6 being a post processor has the important advantage that it provides sufficient echo suppression and robustness at all times. The output signal of the echo post processor 6 indicated r′[k] is coupled to the far end. The operation of the post processor 6 is considered to be well known, but can for example be taken from EP-A-0 843 934, whose disclosure is supposed to be include herein by reference thereto. Principally the AEC 1 may be of an arbitrary adaptive filter type. Examples of suitable algorithms for adjusting coefficients of the echo canceller are: the Least Mean Square (LMS) or Normalized LMS algorithm, or the Recursive Least Square (RLS) algorithm.

At the start of a communication session between the far end speaker and the near end speaker the adaptive filter 4 and thereafter the spectral processor 6 start to converge to a model of the acoustic impulse response between the loudspeaker 2 and the microphone 3. Depending on the signal type of the far end speaker, the length of the adaptive filter 4 and the step size used in the algorithm it will take some time for the adaptive filter 4 to converge, usually a couple of seconds. During this time the echo suppression—if at all present—is poor resulting in an unpleasant start of the communication between the parties. The general problem is to obtain an accurate spectrum estimate of the echo present in the signal originating from the microphone 3 as quickly as possible. Only thereafter residual echoes can be suppressed by the echo suppressor 8, followed by a control of the step size in order to optimize the step size. These problems are difficult to solve if it would be necessary to make use of a complex and critical speech detector.

Thereto use is made of an echo model mismatch compensator 7, included in the overall scheme of the echo canceller of FIG. 2. The compensator 7 is detailed in FIG. 3. FIG. 2 shows respective signal analysis blocks A performing a spectral analysis and conversion on each of the above mentioned signals r[k], z[k], and ŷ[k]. The conversions result in amplitude and phase representations of these signals, schematically indicated ρ and ø respectively. Only the phase ø(R) of processor input signal r[k] is used, together with a modified power spectrum R′_{mod}(k) for reconstruction of the output signal r′[k] by a synthesis block S. The modification of R′_{mod}(k) will be explained later. Long after the start of a communication session, that is in case of a steady state, the adaptive filter 4 has already converged and R′_{mod}(k) then represents unmodified former spectral values R′, wherein residual echoes are being suppressed by residual spectral echo suppressor 8, while use is made of Ŷ(k). Because in that case the output Ŷ_{mod}(k) of the echo model mismatch compensator 7 equals its unmodified input Ŷ(k), which represents the power spectral part of the estimated output signal ŷ[k] of the converged adaptive filter 4. From FIG. 3 it can be seen that the frequency dependent model mismatch estimate G defined by |Ŷ_{mod}|=G|Ŷ|, equals 1 for all frequency bins, long after the start of the communication session. It is now proposed to calculate the estimate G for each frequency bin j, in case Ŷ[(k−i)B]ⱼ>0, in accordance with:
G[kB]ⱼ=min_{iε{0, . . . , L-1}}{|Z[(k−i)B]ⱼ|/|Ÿ[(k−i)B]ⱼ|} (1)
where Zⱼ and Ŷⱼ represent the spectral amplitude in frequency bin j of the microphone signal z[k] and the adaptive filter output signal ŷ[k] respectively, and where ‘min’ means that the minimum of the absolute value ratio between accolades is tracked over a time span covering a number of L time frames out of a total of k blocks having a block size B. If it holds that Ŷ[(k−i)B]ⱼ=0 than the absolute value ratio in equation (1) above is set to infinity. The effect of applying the minimum tracking operation in equation (1) is that a presence of local near end speech (shown dotted in FIG. 4) will not lead to an increase of G[kB]ⱼ and thus to an unwanted upward bias of the echo model mismatch estimate. So at the start of the communication session speech will not adversely influence the building up of the echo model, because use is made of equation (1) generating a mismatch signal represented by |Ŷ_{mod}|, which signal shows a decay which is speech independent.

This behavior is graphically displayed in FIG. 4, which shows the schematic decay of the estimate G as a function of time. Herein the not increasing—flat—parts of G represent periods of speech, whose adverse effects on the model of the echo estimate are flattened out. This leads to undistorted speech.

In situations without any excitation or speech in any frequency bin j for a period longer that L frames the model mismatch is set to infinity. Since the amount of echo suppression by the spectral post processor 6 is zero in case of zero excitation, there will be no distortion of the wanted signal.

The time span covered by equation (1) preferably contains at least one pause in the speech. In practice the time span will last at least 4 to 5 seconds. The echo model mismatch compensator 7 may comprise well known shift registers, which may store consecutive calculated values of the ratios numerator and denominator.

FIG. 2 also shows that the echo canceller 1 comprises a step size estimator 8 in particular coupled to the echo model mismatch compensator 7. This has the additional effect that—also—during start up of the communication session the step size used in the algorithm can be optimized at an earlier stage in the communication. This early optimization is independent from the applied step size control or from the way the step size estimator 8 operates. As far as the estimator 8 for made use of Ŷ for every frequency bin, this quantity may simply be replaced by the associated Ŷ_{mod} specified above, in order to reveal the advantageous results during the start up of the communication session. Without going into further details the step size can be optimized in terms of Ŷ_{mod} for effecting a full band optimal step size, both during start up and consequent steady state. Furthermore the step size control can be realized in a frequency dependent manner.

Equivalent to the echo model mismatch estimate described above a noise cancellation term can similarly be proposed in order to introduce an associated noise model mismatch estimate, either or not combined with the echo model mismatch estimate. FIGS. 5 and 6 shows respective embodiments of the interference canceller 1 now to be described, which are embodied as a noise canceller 1. Also referring to FIG. 1 it can be seen that the overall view is quite similar to the build ups of FIGS. 5 and 6, except that the loudspeaker 2 has been replaced by a reference signal microphone 9. The microphone 9 senses the reference signal, now the noise signal, which noise signal together with the speech is sensed by the microphone 3. The adaptive filter 4 models the noise path between microphones 9 and 3. The signal z[k] now contains the speech s[k] and noise n[k]. The noise estimate ñ[k] modeled by the adaptive filter 4 may be processed in a similar way as ŷ[k] in the post processor embodiment of FIG. 2. So finally echo and/or noise are treated similarly.

FIG. 6 shows an embodiment of the interference canceller 1 in the form of a noise canceller, wherein the loudspeaker in FIG. 1 has been replaced by a reference microphone 9, which apart from noise n[k] also senses part of the speech s[k]. Like in FIG. 5 microphone 3 senses speech and noise. A beam former 10 is included in the noise canceller 1 for separating noise now included in a noise signal n′[k] and a signal z′[k] comprising speech and noise. The operation of the beam former is known from WO 99/27522, whose disclosure is included here by reference thereto. The noise estimate ñ′[k] is treated similar to the noise estimate ñ[k] of FIG. 5.

With the interference model mismatch estimate of the interference canceller 1, the echo and/or noise power spectrum can be estimated very accurately leading to a significant improvement of the acoustic canceller 1 in case the adaptive filter 4 is in an earlier state of convergence. Especially in the initial convergence phase a high quality operation of the acoustic canceller is important as this determines the first impression of the user.

Whilst the above has been described with reference to essentially preferred embodiments and best possible modes it will be understood that these embodiments are by no means to be construed as limiting examples of the systems and method concerned, because various modifications, features and combination of features falling within the scope of the appended claims are now within reach of the skilled person.

1. Interference canceller comprising an adaptive filter for modeling an interference, and a spectral processor for processing the modeled interference together with near end speech and the actual interference, characterized in that the interference canceller further comprises an interference model mismatch compensator coupled to the adaptive filter for providing a mismatch signal for the spectral processor, said mismatch signal showing a speech independent decay.

2. Interference canceller according to claim 2, characterized in that the interference canceller comprises a step size estimator coupled to the interference model mismatch compensator.

3. Interference canceller according to claim 1, characterized in that the interference model mismatch compensator is arranged for calculating an interference model mismatch estimate based on a minimum of the ratio of a spectral measure of the near end speech and actual interference, and the modeled interference of the adaptive filter.

4. Interference canceller according to claim 3, characterized in that the minimum of said ratio is determined over a time span.

5. Interference canceller according to claim 4, characterized in that the time span contains at least one pause in the speech.

6. Interference canceller according to claim 4, characterized in that the time span lasts at least 4 to 5 seconds.

7. Interference canceller according to claim 3, characterized in that the spectral measure is defined by some positive function of the spectral power concerned, such as the spectral magnitude, the squared spectral magnitude, the power spectral density or the Mel-scale spectral density.

8. Interference canceller according to claim 1, characterized in that the interference canceller is embodied as an echo canceller and/or a noise canceller.

9. System, in particular a communication system, for example a hands-free communication device, such as a mobile telephone, a speech recognition system or a voice controlled system, which system is provided with an interference canceller according to claim 1, the interference canceller comprising an adaptive filter for modeling an actual interference, and a spectral processor for processing the modeled interference together with near end speech and the actual interference, characterized in that the interference canceller further comprises an interference model mismatch compensator coupled to the adaptive filter for providing a mismatch signal for the spectral processor, said mismatch signal showing a speech independent decay.

10. Method for cancelling an interference, whereby an actual interference is modeled and the modeled interference, together with near end speech and the actual interference are processed, characterized in that an interference model mismatch signal is used for modeling the actual interference, which mismatch signal shows a speech independent decay.

11. Signals suited for use in the interference canceller according to claim 1, the interference canceller comprising an adaptive filter for modeling an actual interference, and a spectral processor for processing the modeled interference together with near end speech and the actual interference, characterized in that the interference canceller further comprises an interference model mismatch compensator coupled to the adaptive filter for providing a mismatch signal to the spectral processor, said mismatch signal showing a speech independent decay.
